(19) United States
(12) Patent Application Publication
(10) Pub. No.: US 2020/0033465 A1
(43) Pub. Date: Jan. 30, 2020

(54) OPTIMIZED CAPTURING WINDOW IN A DISTANCE MEASURING SYSTEM

(71) Applicant: Sony Mobile Communications Inc, Tokyo (JP)

(72) Inventors: Mattias FALK, Tokyo (JP); Thomas FÄNGE, Tokyo (JP); Hannes BERGKVIST, Tokyo (JP); Ivar BERGKVIST, Tokyo (JP)

(21) Appl. No.: 16/436,281

(22) Filed: Jun. 10, 2019

(30) Foreign Application Priority Data
Jul. 26, 2018 (SE) 1830224-0

(51) Int. Cl. G01S 11/16

(52) U.S. Cl. CPC G01S 11/16

(57) ABSTRACT

A second device for measuring a distance from a first device is provided. The second device includes an electromagnetic receiver configured to receive an electromagnetic signal transmitted by the first device at a first time and a sound receiver configured to receive a sound signal transmitted by the first device at a second time. The electromagnetic signal and the sound signal are transmitted substantially at the same time. The second device also includes a processor configured to approximate the distance of the second device from the first device based on the first time, set a capturing window for capturing the sound signal based on the approximated distance and capture the sound signal within the set capturing window. The processor is configured to determine the distance of the second device from the first device based on the first time and the captured sound signal.

### FIELD OF INVENTION

The present invention relates generally to distance measuring systems, and more particularly to a distance measuring system with an optimized capturing window.

### BACKGROUND OF THE INVENTION

Cricket is an indoor location or distance measuring system that uses a combination of radio frequency (RF) and ultrasound (US) technologies to provide location information, such as space identifiers, position coordinates, and orientation of objects to a host device. Cricket systems use two types of devices, including listeners and beacons, each having an RF transceiver, a microcontroller, and other associated hardware for generating and receiving RF and US signals and interfacing with the host device.

Objects to be monitored are equipped with listeners, also referred to herein as receiving devices, configured to receive RF and US signals transmitted by various beacons, also referred to herein as transmitting devices, placed throughout an indoor area as fixed reference points. The objects to be monitored may be stationary or mobile. To determine the location of an object, or to measure the object's distance from a transmitting device, the transmitting device transmits RF and US signals substantially at the same time. When a receiving device receives both the RF and the US signal from a given transmission, the distance of the receiving device from the corresponding transmitting device may be calculated by taking into account the difference in arrival time of the RF and US signals, considering the propagation speeds of the RF signal (traveling at the speed of light) and the US signal (traveling at the speed of sound). In particular, the Cricket system measures the distance of a receiving device from a transmitting device by comparing the time of flight (ToF) of the RF and US signals.

To ensure that the receiving device captures enough of the US signal transmitted by the transmitting device, conventional distance measuring systems use a static capturing window for capturing signal data. The static capturing window is determined by the maximum available memory on the receiving device and/or a given range of distance measuring. The maximum available memory on the receiving device in particular may vary according to the specific hardware being used in the system.

With reference to FIG. 1, various examples of the operation of receiving devices receiving US signals (s₁, s₂, . . . sₙ) at various example distances (d₁, d₂, . . . dₙ) from a transmitting device are depicted in a graphical schematic 10 for a conventional distance measuring system. In the graphical schematic 10, where time is represented on the x-axis and distance is represented on the y-axis, the time and distance ranges created by the static capturing window (wₛ) are depicted. For example, when the conventional system begins capturing data immediately upon the transmission of the signals from the transmitting device (at T), and captures data continuously for the entire wₛ, a maximum distance (dₘₐₓ) is created at which the conventional system is capable of measuring objects.

S₁, for example, depicts a when a US signal is received by a receiving device located at d₁. In this example, as d₁ is within the distance range created by wₛ, the US signal may be fully captured by the conventional system at s₁ within wₛ. Similarly, because d₂ is also within the distance range created by wₛ, a US signal, depicted by 52, may also be captured when it is received by a receiving device located at d₂. As depicted in FIG. 1, however, any US signal that is received by a receiving device located past dₘₐₓ, depicted as sₙ for a receiving device located at dₙ, cannot be captured by the conventional system, as it is outside wₛ.

Not only are time and distance limitations created by wₛ, but the use of wₛ in a conventional distance measuring system also results in the capturing of irrelevant data, represented by the bolded line, that does not include the transmitted US signal before the receiving device receives the transmitted US signal and after the transmitted US signal has passed the receiving device. This not only uses an unnecessary amount of memory, but consumes an unnecessary amount of power to process the irrelevant data. There also exists a risk of capturing reflections of the US signal, which may lead to complications in the resulting distance calculation.

To mitigate these problems, the distance measuring system may alternatively begin capturing data upon receipt of the RF signal, as the RF signal will travel faster than the US signal. Even in this scenario, however, substantial irrelevant data not including the transmitted US signal will still be captured in the time between receipt of the RF signal and receipt of the US signal and after the US signal has passed. Furthermore, the capturing window must be long enough to capture the entire length of the transmitted US signal. For example, when the receiving device is located 50 m from the transmitting device, the system must capture for long enough to cover both the time it takes for the US signal to travel 50 m, plus the duration of the actual signal.

### SUMMARY OF THE INVENTION

A distance measuring system is therefore provided with an optimized capturing window that avoids capturing unnecessary and irrelevant data, and reduces the receiving device's memory and power consumption. According to aspects of the present invention, a distance measuring system uses a receiving device configured to approximate the distance of the receiving device from the transmitting device using the ToF of the transmitted RF signal, and uses that approximated distance to set an optimized capturing window. The optimized capturing window may be set by determining a start time of the capturing window and setting the capturing window as a fixed duration beginning at the start time, or may alternatively be set by determining both a start time and an end time and setting the capturing window to be between the start time and the end time. In this way, the capturing window will be adjusted to capture the transmitted US signal regardless of the distance between the transmitting device and the receiving device and to avoid capturing irrelevant data not including the US signal.

According to an aspect of the invention, a second device for measuring a distance from a first device is provided. The second device comprises an electromagnetic receiver configured to receive an electromagnetic signal, wherein the electromagnetic signal is received at a first time and the electromagnetic signal is transmitted by the first device. The second device also comprises a sound receiver configured to receive a sound signal, wherein the sound signal is received at a second time after the first time and the sound signal is transmitted by the first device. The electromagnetic signal and the sound signal are transmitted substantially at the same time. The second device also comprises a processor configured to approximate the distance of the second device from the first device based on the first time. The processor is also configured to set a capturing window for capturing the sound signal based on the approximated distance of the second device from the first device and capture the sound signal received by the second device within the set capturing window. The processor is also configured to determine the distance of the second device from the first device based on the first time and the captured sound signal.

In an embodiment, to set the capturing window, the processor of the second device is configured to determine a capturing start time based on the approximated distance of the second device from the first device and set the capturing window as a fixed duration to begin at the capturing start time.

In an embodiment, the processor is configured to determine the capturing start time to be shortly prior to the second time.

In another embodiment, to set the capturing window, the processor of the second device is configured to determine a capturing start time based on the approximated distance of the second device from the first device, and determine a capturing end time based on the approximated distance of the second device from the first device and a length of the sound signal. The processor is then configured to set the capturing window to begin at the capturing start time and to end at the capturing end time.

In an embodiment, the processor is configured to determine the capturing start time to be shortly prior to the second time and to determine the capturing end time to be shortly after the second time and the length of the sound signal.

In another embodiment, the electromagnetic receiver of the second device is a radio antenna and the sound receiver of the second device is a microphone.

In yet another embodiment, the electromagnetic signal is a radio signal.

In another embodiment, the sound signal is an ultrasound signal.

According to another aspect of the invention, a distance measuring system is provided. The distance measuring system comprises a first device configured to transmit an electromagnetic signal and a sound signal, wherein the electromagnetic signal and the sound signal are transmitted substantially at the same time. The distance measuring system also comprises a second device located at a distance from the first device. The second device is configured to receive the electromagnetic signal, wherein the electromagnetic signal is received at a first time, and receive the sound signal, wherein the sound signal is received at a second time after the first time. The second device is also configured to approximate the distance of the second device from the first device based on the first time, set a capturing window for capturing the sound signal based on the approximated distance of the second device from the first device, and capture the sound signal received by the second device within the set capturing window. The second device is then configured to determine the distance of the second device from the first device based on the first time and the captured sound signal.

In an embodiment, to set the capturing window, the second device of the distance measuring system is configured to determine a capturing start time based on the approximated distance of the second device from the first device, and set the capturing window as a fixed duration to begin at the capturing start time.

In an embodiment, the second device is configured to determine the capturing start time to be shortly prior to the second time.

In another embodiment, to set the capturing window, the second device of the distance measuring system is configured to determine a capturing start time based on the approximated distance of the second device from the first device, determine a capturing end time based on the approximated distance of the second device from the first device and a length of the sound signal, and set the capturing window to begin at the capturing start time and to end at the capturing end time.

In an embodiment, the second device is configured to determine the capturing start time to be shortly prior to the second time and to determine the capturing end time to be shortly after the second time and the length of the sound signal.

In another embodiment, the second device of the distance measuring system comprises an electromagnetic receiver configured to receive the electromagnetic signal and a sound receiver configured to receive the sound signal.

In yet another embodiment, the electromagnetic receiver of the second device is a radio antenna and the sound receiver of the second device is a microphone.

In another embodiment, the first device in the distance measuring system transmits the electromagnetic signal as a radio signal.

According to another aspect of the invention, a method, performed by a second device, of measuring a distance from a first device is provided. The method comprises receiving an electromagnetic signal transmitted by the first device, wherein the electromagnetic signal is received at a first time, and approximating the distance of the second device from the first device based on the first time. The method also comprises setting a capturing window for capturing a sound signal transmitted by the first device, wherein setting the capturing window is based on the approximated distance of the second device from the first device. The method also comprises receiving the sound signal, wherein the sound signal is received at a second time after the first time. The method also comprises capturing the sound signal received by the second device within the set capturing window, and determining the distance of the second device from the first device based on the first time and the captured sound signal.

In an embodiment, setting the capturing window in the method comprises determining a capturing start time based on the approximated distance of the second device from the first device and setting the capturing window as a fixed duration to begin at the capturing start time.

In an embodiment, determining the capturing start time comprises determining the capturing start time to be shortly prior to the second time.

In another embodiment, setting the capturing window in the method comprises determining a capturing start time based on the approximated distance of the second device from the first device, determining a capturing end time based on the approximated distance of the receiving device from the transmitting device and a length of the sound signal, and setting the capturing window to begin at the capturing start time and to end at the capturing end time.

In an embodiment, determining the capturing start time comprises determining the capturing start time to be shortly prior to the second time, and determining the capturing end time comprises determining the capturing end time to be shortly after the second time and the length of the sound signal.

In another embodiment, the second device provided in the method comprises an electromagnetic receiver for receiving the electromagnetic signal and a sound receiver for receiving the sound signal.

In yet another embodiment, the electromagnetic receiver is a radio antenna and the sound receiver is a microphone.

According to another aspect of the invention, a method of measuring distance is provided. The method comprises providing a first device and a second device located at a distance from each other. The method comprises transmitting, by the first device, an electromagnetic signal and a sound signal, wherein the electromagnetic signal and the sound signal are transmitted substantially at the same time. The method comprises receiving, by the second device, the electromagnetic signal, wherein the electromagnetic signal is received at a first time, and approximating, by the second device, the distance of the second device from the first device based on the first time. The method also comprises setting, by the second device, a capturing window for capturing the sound signal based on the approximated distance of the second device from the first device. The method also comprises receiving, by the second device, the sound signal, wherein the sound signal is received at a second time after the first time. The method also comprises capturing, by the second device, the sound signal received by the second device within the set capturing window, and determining the distance of the second device from the first device based on the first time and the captured sound signal.

In an embodiment, setting the capturing window in the method comprises determining, by the second device, a capturing start time based on the approximated distance of the second device from the first device, and setting, by the second device, the capturing window as a fixed duration to begin at the capturing start time.

In an embodiment, determining, by the second device, the capturing start time comprises determining the capturing start time to be shortly prior to the second time.

In another embodiment, setting the capturing window in the method comprises determining, by the second device, a capturing start time based on the approximated distance of the second device from the first device, determining, by the second device, a capturing end time based on the approximated distance of the second device from the first device and a length of the sound signal, and setting, by the second device, the capturing window to begin at the capturing start time and to end at the capturing end time.

In an embodiment, determining, by the second device, the capturing start time comprises determining the capturing start time to be shortly prior to the second time and determining, by the second device, the capturing end time comprises determining the capturing end time to be shortly after the second time and the length of the sound signal.

In another embodiment, the second device provided in the method comprises an electromagnetic receiver for receiving the electromagnetic signal and a sound receiver for receiving the sound signal.

In yet another embodiment, the electromagnetic receiver is a radio antenna and the sound receiver is a microphone.

In yet another embodiment, the transmitting in the method comprises transmitting the electromagnetic signal as a radio signal.

According to another aspect of the invention, a non-transitory computer-readable medium storing program code is provided which when executed by a second device performs the steps of receiving the electromagnetic signal, wherein the electromagnetic signal is received at a first time, and approximating the distance of the second device from the first device based on the first time. The non-transitory computer-readable medium storing program code, when executed by the second device also performs the steps of setting a capturing window for capturing the sound signal based on the approximated distance of the second device from the first device, receiving the sound signal, wherein the sound signal is received at a second time after the first time, capturing the sound signal received by the second device within the set capturing window, and determining the distance of the second device from the first device based on the first time and the captured sound signal.

In an embodiment, the computer-readable medium storing program code, when executed by the second device, performs the step of setting the capturing window by determining a capturing start time based on the approximated distance of the second device from the first device, and setting the capturing window as a fixed duration to begin at the capturing start time.

In another embodiment, the computer-readable medium storing program code, when executed by the second device performs the step of determining the capturing start time to be shortly prior to the second time.

In another embodiment, the computer-readable medium storing program code, when executed by the second device performs the step of setting the capturing window by determining a capturing start time based on the approximated distance of the second device from the first device, determining a capturing end time based on the approximated distance of the second device from the first device and a length of the sound signal, and setting the capturing window to begin at the capturing start time and to end at the capturing end time.

In another embodiment, the computer-readable medium storing program code, when executed by the second device performs the steps of determining the capturing start time to be shortly prior to the second time, and determining the capturing end time to be shortly after the second time and the length of the sound signal.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a graphical schematic of the operation of a conventional distance measuring system.

FIG. 2a is a schematic diagram of an exemplary distance measuring system according to an aspect of the present invention.

FIG. 2b is a graphical schematic of the operation of the exemplary distance measuring system depicted in FIG. 2a.

FIG. 3 is a schematic diagram of an exemplary transmitting device according to an aspect of the present invention.

FIG. 4 is a schematic flow diagram of a method of measuring distance according to an aspect of the present invention.

FIG. 5 is a schematic flow diagram of a method of measuring distance according to another aspect of the present invention.

### DETAILED DESCRIPTION

Embodiments of the present invention will now be described with reference to the drawings, wherein like reference numerals are used to refer to like elements throughout. It will be understood that the figures are not necessarily to scale.

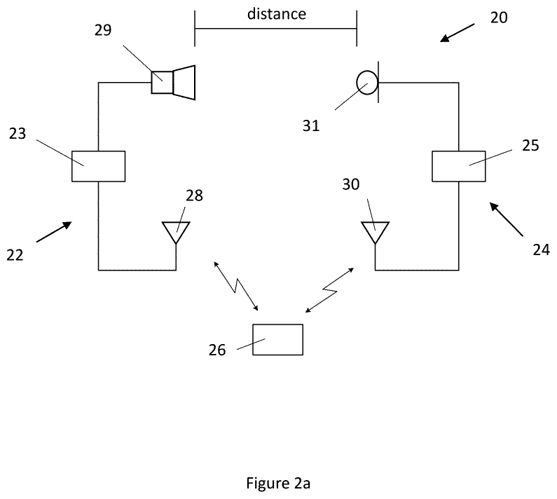

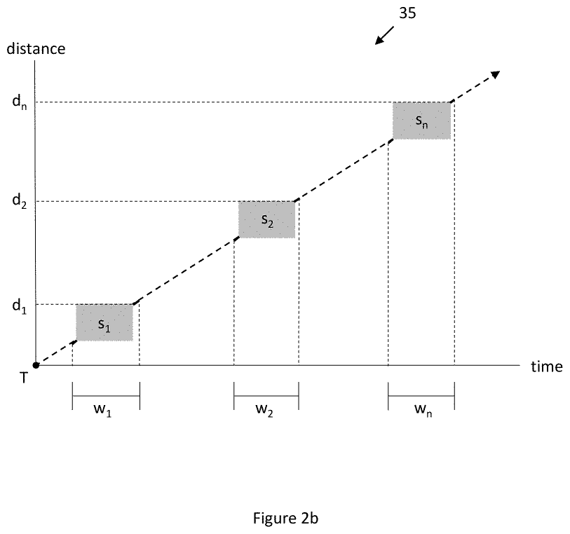

With reference to FIG. 2a, an exemplary distance measuring system 20 is depicted. The distance measuring system 20 comprises a first device 22, also referred to herein as a transmitting device, configured to transmit an electromagnetic signal and a sound signal. The transmitting device 22 may be configured to transmit the electromagnetic signal and the sound signal substantially at the same time. For example, due to typical delays, such as group delay and antenna delay in the transmitting device 22, as well as other unknown delays in the distance measuring system 20, a minor discrepancy in the relative timing of transmission of the electromagnetic and sound signals may result. This minor discrepancy may thereafter be accounted for as an estimated error in the resulting distance calculation. The transmitting device 22 may transmit the electromagnetic signal as, for example, a radio signal, also referred to herein as an RF signal. The transmitter 22 may transmit the sound signal as, for example, an ultrasound (US) signal. For simplicity throughout, RF and US will be used to refer to the electromagnetic and sound signals, respectively, though it is to be understood that the electromagnetic and sound signals are not limited to RF and US signals, specifically, but may be any suitable electromagnetic or sound signal.

The transmitting device 22 may comprise an electromagnetic, or RF, transmitter 28 configured to transmit the RF signal and a sound, or US, transmitter 29 configured to transmit the US signal. The RF transmitter may be, for example, a radio antenna and the US transmitter may be, for example, a speaker. In an embodiment, the transmitting device 22 may comprise a single transmitter configured to transmit both the RF signal and the US signal. In this embodiment, the single transmitter may be a plasma transmitter such as, for example, a corona discharge transmitter, configured to simultaneously transmit the RF and US signal. The US signal may be transmitted within a wide range of frequencies. For example, the US signal may be transmitted in a frequency range of approximately 20-40 kHz, although the precise range is not critical. The RF signal may be transmitted within a wide range of ordinary radio frequencies. The transmitting device 22 may comprise a transmitting device processor 23 for controlling the transmitting device 22. The transmitting device processor 23 is therefore configured to carry out overall control of the functions and operations of the transmitting device 22 and may be a central processing unit (CPU), microcontroller, or microprocessor.

The distance measuring system 20 also comprises a second device 24, also referred to herein as a receiving device, located a distance away from the transmitting device 22. The receiving device 24 may be positioned upon an object the distance to which is to be measured. The receiving device 24 may be stationary or mobile, depending upon the object to which the receiving device 24 is fixed or positioned. The receiving device 24 is configured to receive the RF signal and the US signal that are transmitted by the transmitting device 22. The receiving device 24 is configured to receive the RF signal at a first time, also referred to herein as an RF signal receipt time, and to receive the US signal at a second time, also referred to herein as a US signal receipt time. The US signal receipt time is some time after the RF signal receipt time, as the RF signal travels faster than the US signal and will therefore reach the receiving device 24 first. The receiving device 24 may comprise an electromagnetic, or RF, receiver 30 configured to receive the RF signal and a sound, or US, receiver 31 configured to receive the US signal. The RF receiver 30 may be, for example, a radio antenna and the US receiver 31 may be, for example, a microphone. In an embodiment, the receiving device 24 may comprise a single system receiver configured to receive both the RF signal and the US signal. In this embodiment, the single system receiver may be, for example, a receiving plasma antenna. In another example, the single system receiver may be a microphone having microphone circuitry that is subjected to interference by the RF signal. In this example, the microphone may receive the US signal as is conventional for a microphone, and further may receive the RF signal and detect the RF signal by capturing the electromagnetic interference in the microphone circuitry. The receiving device 24 may also comprise a receiving device processor 25 for controlling the receiving device 24. The receiving device processor 25 is therefore configured to carry out overall control of the functions and operations of the receiving device 24 and may be a central processing unit (CPU), a microcontroller, or microprocessor.

In various embodiments, the transmitting device processor 23, the receiving device processor 25, or both may be configured to approximate the distance of the receiving device 24 from the transmitting device 22 based on the RF signal receipt time, set a capturing window for capturing the US signal based on the approximated distance, and capture the US signal within the set capturing window. In another embodiment, however, the distance measuring system 20 may include a remote system processor 26 for performing these functions, based on information received from the transmitting device processor 23 and/or the receiving device processor 25 regarding the transmission and receipt of the RF and/or US signals. The remote system processor 26 may be in wireless or electrical communication with the transmitting device 22, the receiving device 24, or both. The remote system processor 26 may be configured to carry out overall control of the functions and operations of the distance measuring system 20 and may be a central processing unit (CPU), microcontroller, or microprocessor.

The transmitting device processor 23, the receiving device processor 25, and the remote system processor 26 each may execute program code stored in a non-transitory computer readable medium, such as random access memory (RAM), a read-only memory (ROM), an erasable programmable read-only memory (EPROM or Flash memory), or any other suitable memory device incorporated into the distance measuring system 20 or in a separate memory device, to carry out operation of the transmitting device 22, the receiving device 24, and/or the distance measuring system 20, respectively. It will be apparent to a person having ordinary skill in the art of computer programming how to program the processors 23,25,26 to operate and carry out the functions associated with their respective device and/or system. Accordingly, details as to specific programming code have been left out for the sake of brevity. Also, while the code may be executed by the processors 23,25,26 in accordance with an exemplary embodiment, such functionality may also be carried out via dedicated hardware, firmware, software, or combinations thereof, without departing from the scope of the invention.

The transmitting device processor 23, receiving device processor 25, remote system processor 26, and/or any combination thereof, are configured to approximate the distance of the receiving device 24 from the transmitting device 22 based on the RF signal receipt time and, accordingly, the RF ToF. For example, the distance of the receiving device 24 from the transmitting device 22 may be approximated based on a measured signal strength of the RF signal by using the formula: distance=10\hat{ }(((dB@1 meter)−RSSI)/(10*n)). In another example, the distance may be approximated using Two-Way-Ranging wherein the RF signal is one of three signals, as will be appreciated.

The processors 23,25,26, and/or any combination thereof, are configured to set a capturing window for capturing the US signal transmitted by the transmitting device 22 based on the approximated distance of the receiving device 24 from the transmitting device 22. The processors 23,25,26, and/or any combination thereof, are also configured to capture the US signal received by the receiving device 24 within the set capturing window and determine the distance of the receiving device 24 from the transmitting device 22 based on the RF signal receipt time and the captured US signal.

In an embodiment, the processors 23,25,26, and/or any combination thereof, may be configured to set the capturing window by determining a capturing start time based on the approximated distance of the receiving device 24 from the transmitting device 22 and set the capturing window as a fixed duration to begin at the capturing start time. For example, considering the known speed of sound, the US signal receipt time (i.e. the time it takes for the sound signal to travel the approximated distance) may be calculated, accounting for any estimated error in the approximated distance. The capturing start time may then be set to start at, or shortly prior to, this calculated US signal receipt time. In another embodiment, the processors 23,25,26, and/or any combination thereof, may be configured to set the capturing window by determining both a capturing start time and a capturing end time based on the approximated distance of the receiving device 24 from the transmitting device 22 and set the capturing window to begin at the capturing start time and to end at the capturing end time. The capturing end time may be determined based also on the length of the sound signal, or the delay spread (i.e. line of sight), so that the entire length of the sound signal may be captured within the capturing window.

With reference to FIG. 2b, a graphical schematic 35 of various examples of the operation of the receiving device 24 receiving US signals (s₁, s₂, . . . sₙ) at various example distances (d₁, d₂, . . . dₙ) from the transmitting device 22 is depicted. In the graphical schematic 35, where time is represented on the x-axis and distance is represented on the y-axis, the effect of setting an optimized capturing window (w₁, w₂, . . . wₙ) for capturing data according to the distance measuring system 20 of the present invention is depicted. S₁ represents when a US signal is received by the receiving device 24 located at d₁ from the transmitting device 22, s₂ represents when a US signal is received by the receiving device 24 located at d₂ from the transmitting device 22, and sₙ represents when a US signal is received by the receiving device 24 at any other distance dₙ from the transmitting device 22. As depicted, by setting an optimized capturing window for each (w₁, w₂, . . . wₙ), the US signals in each example may be fully captured by the distance measuring system 20 according to the present invention, regardless of the distance of the receiving device 24 from the transmitting device 22.

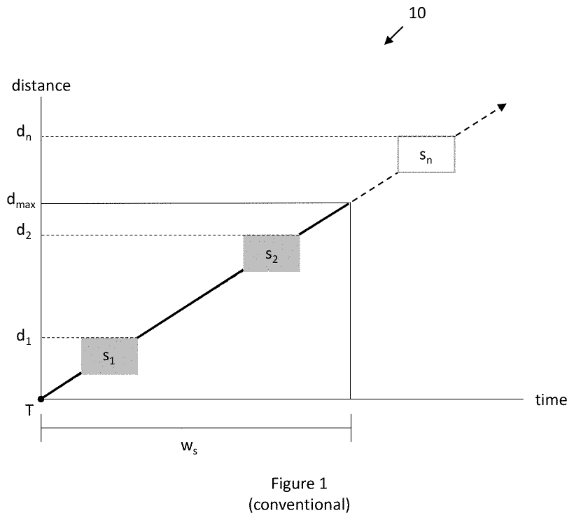

Additionally, the distance measuring system 20 of the present invention avoids capturing as much unnecessary and irrelevant data as the conventional distance measuring system 10 depicted in FIG. 1. The distance measuring system 20 of the present invention also reduces the receiving device's memory and power consumption by setting an optimized capturing window (w₁, w₂, . . . wₙ), as opposed to using a static capturing window for capturing data. The optimized capturing window (w₁, w₂, . . . wₙ) used in the present invention is set by the processor to begin at a capturing start time, and in an embodiment, to also end at a capturing end time. In an embodiment, the capturing start time may be determined to be shortly prior to when receiving device 24 receives the US signal (US signal receipt time) and the capturing end time may be determined to be shortly after the US signal passes the receiving device 24, determined according to the length or duration of the sound signal. For example, for capturing a US signal received at s₁ by the receiving device 24 located at d₁, w₁ may be set to begin shortly before s₁ and to end shortly after the duration of s₁. Similarly, for capturing a US signal received at s₂ by the receiving device 24 located at d₂, w₂ may be set to begin shortly before s₂ and to end shortly after the duration of s₂. This may be done for capturing any US signal received at sₙ by the receiving device 24 located at any dₙ. In this way, the distance measuring system 20 may still avoid capturing a large amount of unnecessary and irrelevant data, while allowing for some margin, depicted as bolded lines in FIG. 2b.

The captured US signal may be stored in a non-transitory computer readable medium, such as any suitable memory device incorporated into the transmitting device 22, the receiving device 24, or in a separate memory device, to be used in a distance measuring calculation of the distance measuring system. A distance of the receiving device 24 from the transmitting device 22 may be determined by the distance measuring calculation based on the RF signal receipt time and the captured US signal, taking into consideration the propagation speeds of the RF signal and the US signal, as previously described.

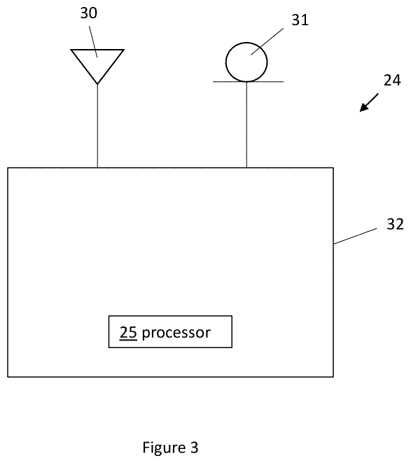

Referring now to FIG. 3, an exemplary second device, such as the receiving device 24, for use in a distance measuring system, such as the distance measuring system 20 previously described, is depicted. The receiving device 24 is located a distance away from a first device, such as the transmitting device 22 in the distance measuring system 20. The receiving device 24 may comprise a housing 32. As previously described for the receiving device 24 in the distance measuring system 20, the receiving device 24 may be positioned upon an object the distance to which is to be measured. The receiving device 24 may be stationary or mobile, depending upon the object to which the receiving device 24 is fixed or positioned. The receiving device 24 is configured to receive an RF signal and a US signal that is transmitted by the transmitting device, such as the transmitting device 22. The receiving device 24 is configured to receive the RF signal at a first, or RF signal receipt time and to receive the US signal at a second, or US signal receipt time. The US signal receipt time is some time after the RF signal receipt time, as the RF signal travels faster than the US signal and will therefore reach the receiving device 24 first. The receiving device 24 may comprise an electromagnetic, or RF, receiver 30 configured to receive the RF signal and a sound, or US, receiver 31 configured to receive the US signal. The RF receiver 30 may be, for example, a radio antenna and the US receiver 31 may be, for example, a microphone. In an embodiment, the receiving device 24 may comprise a single system receiver configured to receive both the RF signal and the US signal. In this embodiment, the single system receiver may be, for example, a receiving plasma antenna. In another example, the single system receiver may be a microphone having microphone circuitry that is subjected to interference by the RF signal. In this example, the microphone may receive the US signal as is conventional for a microphone, and further may receive the RF signal and detect the RF signal by capturing the electromagnetic interference in the microphone circuitry.

The receiving device 24 also comprises a receiving device processor 25 for controlling the receiving device 24. The receiving device processor 25 is configured to carry out overall control of the functions and operations of the receiving device 24 and may be a central processing unit (CPU), a microcontroller, or microprocessor. The receiving device processor 25 may execute program code stored in a non-transitory computer readable medium, such as any suitable memory device incorporated into the receiving device 24 or in a separate memory device, to carry out operation of the receiving device 24. The processor 25 further may perform or control the capturing of the US signal in accordance with the capturing window.

The receiving device processor 25 is configured to approximate the distance of the receiving device 24 from the transmitting device, such as the transmitting device 22, based on the RF signal receipt time and, accordingly, the RF signal ToF. For example, the distance of the receiving device 24 from the transmitting device 22 may be approximated based on a measured signal strength of the RF signal by using the formula: distance=10\hat{ }(((dB@1 meter)−RSSI)/(10*n)). In another example, the distance may be approximated using Two-Way-Ranging wherein the RF signal is one of three signals, as will be appreciated.

The receiving device processor 25 is configured to set a capturing window for capturing the US signal transmitted by the transmitting device, such as the transmitting device 22, based on the approximated distance of the receiving device 24 from the transmitting device. The receiving device processor 25 is also configured to capture the US signal received by the receiving device 24 within the set capturing window and determine the distance of the receiving device 24 from the transmitting device based on the RF signal receipt time and the captured US signal.

In an embodiment, the receiving device processor 25 may be configured to set the capturing window by determining a capturing start time based on the approximated distance of the receiving device 24 from the transmitting device and set the capturing window as a fixed duration to begin at the capturing start time. For example, considering the known speed of sound, the US signal receipt time (i.e. the time it takes for the sound signal to travel the approximated distance) may be calculated, accounting for any estimated error in the approximated distance. The capturing start time may then be set to start at, or shortly prior to, this calculated US signal receipt time. In another embodiment, the receiving device processor 25 may be configured to set the capturing window by determining both a capturing start time and a capturing end time based on the approximated distance of the receiving device 24 from the transmitting device and set the capturing window to begin at the capturing start time and to end at the capturing end time. The capturing end time may be determined based also on the length of the sound signal, or the delay spread (i.e. line of sight), so that the entire length of the sound signal may be captured within the capturing window.

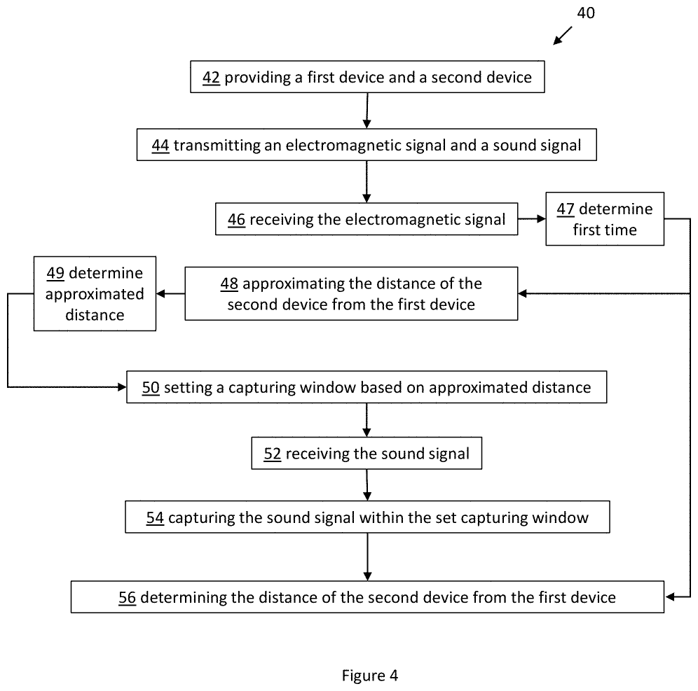

With reference to FIG. 4, a method 40 of measuring distance according to another aspect of the present invention is depicted. The method 40 includes providing, at step 42, a first (transmitting) device and a second (receiving) device located a distance away from the transmitting device. The transmitting device may be a transmitting device such as the transmitting device 22 previously described. The receiving device may be a receiving device such as the receiving device 24 previously described. The method 40 may also include providing a processor, such as the transmitting device processor 23 previously described, the receiving device processor 25 previously described, or the remote system processor 26 previously described.

The method 40 includes transmitting, at step 44 by the first device, an electromagnetic signal and a sound signal. The electromagnetic signal and the sound signal may be transmitted substantially at the same time. Transmitting the electromagnetic signal at step 44 may include transmitting the electromagnetic signal as, for example, a radio signal, also referred to herein as an RF signal. Transmitting the sound signal at step 44 may include transmitting the sound signal as, for example, an ultrasound (US) signal. Again, for simplicity, RF and US will be used to refer to the electromagnetic and sound signals, respectively, though it is to be understood that the electromagnetic and sound signals are not limited to RF and US signals, specifically, but may be any suitable electromagnetic or sound signal.

The method also 40 includes receiving, at step 46 by the second device, the RF signal at a first, or RF signal receipt time. Accordingly, the method 40 comprises determining, at step 47, the first, or RF signal receipt time upon receiving the RF signal. The method 40 then comprises approximating, at step 48 by the second device and/or at least one of the processors, the distance of the receiving device from the transmitting device based on the RF signal receipt time and, accordingly, the RF ToF. Therefore, the method 40 includes determining, at step 49 by the second device and/or at least one of the processors, the approximated distance.

Once the approximated distance is determined at step 49, the method 40 includes setting, at step 50 by the second device and/or at least one of the processors, a capturing window based on the approximated distance of the receiving device from the transmitting device. The method 40 includes receiving, at step 52 by the second device, the US signal transmitted by the transmitting device in step 44 and capturing, at step 54 by the second device and/or at least one of the processors, the US signal within the capturing window set at step 50. The method 40 then includes determining, at step 56 by the second device or at least one of the processors, the distance of the receiving device from the transmitting device based on the RF signal receipt time and the captured US signal. In an embodiment, setting the capturing window at step 50 may comprise determining a capturing start time based on the approximated distance of the receiving device from the transmitting device and setting the capturing window as a fixed duration to begin at the capturing start time. In another embodiment, setting the capturing window at step 50 may comprise determining both a capturing start time and a capturing end time based on the approximated distance of the receiving device from the transmitting device and setting the capturing window to begin at the capturing start time and to end at the capturing end time. The capturing end time may be determined based also on the length of the sound signal, or the delay spread (i.e. line of sight), so that the entire length of the sound signal may be captured within the capturing window.

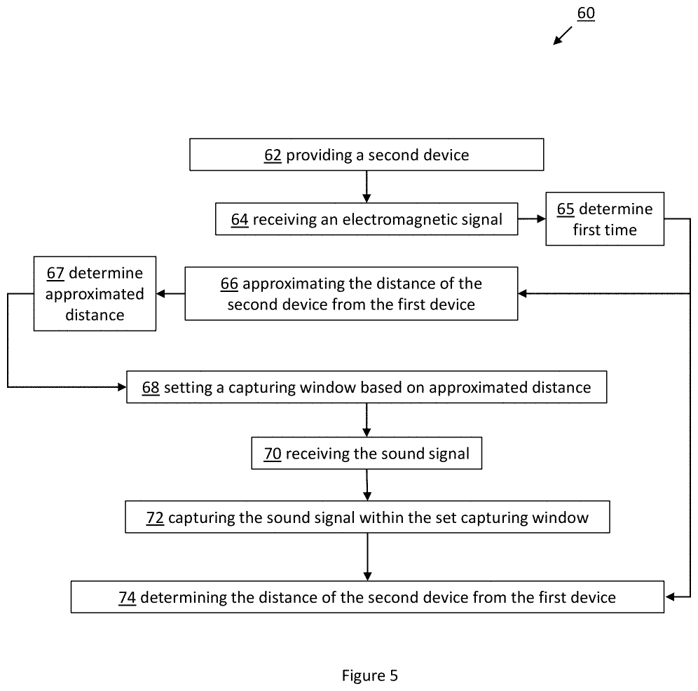

With reference to FIG. 5, a method 60 of measuring distance according to another aspect of the present invention is depicted. The method 60 includes providing, at step 62, a second (receiving) device located a distance away from a transmitting device. The transmitting device may be a transmitting device such as the transmitting device 22 previously described. The receiving device may be a receiving device such as the receiving device 24 previously described. The method 60 may also include providing a processor, such as the transmitting device processor 23 previously described, the receiving device processor 25 previously described, or the remote system processor 26 previously described.

The method 60 includes receiving, at step 64 by the second device, an RF signal transmitted by the transmitting device at an RF signal receipt time. Accordingly, the method 60 comprises determining, at step 65, the RF signal receipt time upon receiving the RF signal. The method 60 then comprises approximating, at step 66 by the second device and/or at least one of the processors, the distance of the receiving device from the transmitting device based on the RF signal receipt time and, accordingly, the RF ToF. Therefore, the method 60 includes determining, at step 67 by the second device and/or at least one of the processors, the approximated distance.

Once the approximated distance is determined at step 67, the method 60 includes setting, at step 68 by the second device and/or at least one of the processors, a capturing window based on the approximated distance of the receiving device from the transmitting device. The method 60 includes receiving, at step 70 by the second device, a US signal transmitted by the transmitting device and capturing, at step 72 by the second device and/or at least one of the processors, the US signal within the capturing window set at step 68. The method 60 then includes determining, at step 74 by the second device or at least one of the processors, the distance of the receiving device from the transmitting device based on the RF signal receipt time and the captured US signal. In an embodiment, setting the capturing window at step 68 may comprise determining a capturing start time based on the approximated distance of the receiving device from the transmitting device and setting the capturing window as a fixed duration to begin at the capturing start time. In another embodiment, setting the capturing window at step 68 may comprise determining both a capturing start time and a capturing end time based on the approximated distance of the receiving device from the transmitting device and setting the capturing window to begin at the capturing start time and to end at the capturing end time. The capturing end time may be determined based also on the length of the sound signal, or the delay spread (i.e. line of sight), so that the entire length of the sound signal may be captured within the capturing window.

According to an aspect of the invention, a second device for measuring a distance from a first device is provided. The second device comprises an electromagnetic receiver configured to receive an electromagnetic signal, wherein the electromagnetic signal is received at a first time and the electromagnetic signal is transmitted by the first device. The second device also comprises a sound receiver configured to receive a sound signal, wherein the sound signal is received at a second time after the first time and the sound signal is transmitted by the first device. The electromagnetic signal and the sound signal are transmitted substantially at the same time. The second device also comprises a processor configured to approximate the distance of the second device from the first device based on the first time. The processor is also configured to set a capturing window for capturing the sound signal based on the approximated distance of the second device from the first device and capture the sound signal received by the second device within the set capturing window. The processor is also configured to determine the distance of the second device from the first device based on the first time and the captured sound signal.

In an embodiment, to set the capturing window, the processor of the second device is configured to determine a capturing start time based on the approximated distance of the second device from the first device and set the capturing window as a fixed duration to begin at the capturing start time.

In an embodiment, the processor is configured to determine the capturing start time to be shortly prior to the second time.

In another embodiment, to set the capturing window, the processor of the second device is configured to determine a capturing start time based on the approximated distance of the second device from the first device, and determine a capturing end time based on the approximated distance of the second device from the first device and a length of the sound signal. The processor is then configured to set the capturing window to begin at the capturing start time and to end at the capturing end time.

In an embodiment, the processor is configured to determine the capturing start time to be shortly prior to the second time and to determine the capturing end time to be shortly after the second time and the length of the sound signal.

In another embodiment, the electromagnetic receiver of the second device is a radio antenna and the sound receiver of the second device is a microphone.

In yet another embodiment, the electromagnetic signal is a radio signal.

In another embodiment, the sound signal is an ultrasound signal.

According to another aspect of the invention, a distance measuring system is provided. The distance measuring system comprises a first device configured to transmit an electromagnetic signal and a sound signal, wherein the electromagnetic signal and the sound signal are transmitted substantially at the same time. The distance measuring system also comprises a second device located at a distance from the first device. The second device is configured to receive the electromagnetic signal, wherein the electromagnetic signal is received at a first time, and receive the sound signal, wherein the sound signal is received at a second time after the first time. The second device is also configured to approximate the distance of the second device from the first device based on the first time, set a capturing window for capturing the sound signal based on the approximated distance of the second device from the first device, and capture the sound signal received by the second device within the set capturing window. The second device is then configured to determine the distance of the second device from the first device based on the first time and the captured sound signal.

In an embodiment, to set the capturing window, the second device of the distance measuring system is configured to determine a capturing start time based on the approximated distance of the second device from the first device, and set the capturing window as a fixed duration to begin at the capturing start time.

In an embodiment, the second device is configured to determine the capturing start time to be shortly prior to the second time.

In another embodiment, to set the capturing window, the second device of the distance measuring system is configured to determine a capturing start time based on the approximated distance of the second device from the first device, determine a capturing end time based on the approximated distance of the second device from the first device and a length of the sound signal, and set the capturing window to begin at the capturing start time and to end at the capturing end time.

In an embodiment, the second device is configured to determine the capturing start time to be shortly prior to the second time and to determine the capturing end time to be shortly after the second time and the length of the sound signal.

In another embodiment, the second device of the distance measuring system comprises an electromagnetic receiver configured to receive the electromagnetic signal and a sound receiver configured to receive the sound signal.

In yet another embodiment, the electromagnetic receiver of the second device is a radio antenna and the sound receiver of the second device is a microphone.

In another embodiment, the first device in the distance measuring system transmits the electromagnetic signal as a radio signal.

According to another aspect of the invention, a method, performed by a second device, of measuring a distance from a first device is provided. The method comprises receiving an electromagnetic signal transmitted by the first device, wherein the electromagnetic signal is received at a first time, and approximating the distance of the second device from the first device based on the first time. The method also comprises setting a capturing window for capturing a sound signal transmitted by the first device, wherein setting the capturing window is based on the approximated distance of the second device from the first device. The method also comprises receiving the sound signal, wherein the sound signal is received at a second time after the first time. The method also comprises capturing the sound signal received by the second device within the set capturing window, and determining the distance of the second device from the first device based on the first time and the captured sound signal.

In an embodiment, setting the capturing window in the method comprises determining a capturing start time based on the approximated distance of the second device from the first device and setting the capturing window as a fixed duration to begin at the capturing start time.

In an embodiment, determining the capturing start time comprises determining the capturing start time to be shortly prior to the second time.

In another embodiment, setting the capturing window in the method comprises determining a capturing start time based on the approximated distance of the second device from the first device, determining a capturing end time based on the approximated distance of the receiving device from the transmitting device and a length of the sound signal, and setting the capturing window to begin at the capturing start time and to end at the capturing end time.

In an embodiment, determining the capturing start time comprises determining the capturing start time to be shortly prior to the second time, and determining the capturing end time comprises determining the capturing end time to be shortly after the second time and the length of the sound signal.

In another embodiment, the second device provided in the method comprises an electromagnetic receiver for receiving the electromagnetic signal and a sound receiver for receiving the sound signal.

In yet another embodiment, the electromagnetic receiver is a radio antenna and the sound receiver is a microphone.

According to another aspect of the invention, a method of measuring distance is provided. The method comprises providing a first device and a second device located at a distance from each other. The method comprises transmitting, by the first device, an electromagnetic signal and a sound signal, wherein the electromagnetic signal and the sound signal are transmitted substantially at the same time. The method comprises receiving, by the second device, the electromagnetic signal, wherein the electromagnetic signal is received at a first time, and approximating, by the second device, the distance of the second device from the first device based on the first time. The method also comprises setting, by the second device, a capturing window for capturing the sound signal based on the approximated distance of the second device from the first device. The method also comprises receiving, by the second device, the sound signal, wherein the sound signal is received at a second time after the first time. The method also comprises capturing, by the second device, the sound signal received by the second device within the set capturing window, and determining the distance of the second device from the first device based on the first time and the captured sound signal.

In an embodiment, setting the capturing window in the method comprises determining, by the second device, a capturing start time based on the approximated distance of the second device from the first device, and setting, by the second device, the capturing window as a fixed duration to begin at the capturing start time.

In an embodiment, determining, by the second device, the capturing start time comprises determining the capturing start time to be shortly prior to the second time.

In another embodiment, setting the capturing window in the method comprises determining, by the second device, a capturing start time based on the approximated distance of the second device from the first device, determining, by the second device, a capturing end time based on the approximated distance of the second device from the first device and a length of the sound signal, and setting, by the second device, the capturing window to begin at the capturing start time and to end at the capturing end time.

In an embodiment, determining, by the second device, the capturing start time comprises determining the capturing start time to be shortly prior to the second time and determining, by the second device, the capturing end time comprises determining the capturing end time to be shortly after the second time and the length of the sound signal.

In another embodiment, the second device provided in the method comprises an electromagnetic receiver for receiving the electromagnetic signal and a sound receiver for receiving the sound signal.

In yet another embodiment, the electromagnetic receiver is a radio antenna and the sound receiver is a microphone.

In yet another embodiment, the transmitting in the method comprises transmitting the electromagnetic signal as a radio signal.

According to another aspect of the invention, a non-transitory computer-readable medium storing program code is provided which when executed by a second device performs the steps of receiving the electromagnetic signal, wherein the electromagnetic signal is received at a first time, and approximating the distance of the second device from the first device based on the first time. The non-transitory computer-readable medium storing program code, when executed by the second device also performs the steps of setting a capturing window for capturing the sound signal based on the approximated distance of the second device from the first device, receiving the sound signal, wherein the sound signal is received at a second time after the first time, capturing the sound signal received by the second device within the set capturing window, and determining the distance of the second device from the first device based on the first time and the captured sound signal.

In an embodiment, the computer-readable medium storing program code, when executed by the second device, performs the step of setting the capturing window by determining a capturing start time based on the approximated distance of the second device from the first device, and setting the capturing window as a fixed duration to begin at the capturing start time.

In another embodiment, the computer-readable medium storing program code, when executed by the second device performs the step of determining the capturing start time to be shortly prior to the second time.

In another embodiment, the computer-readable medium storing program code, when executed by the second device performs the step of setting the capturing window by determining a capturing start time based on the approximated distance of the second device from the first device, determining a capturing end time based on the approximated distance of the second device from the first device and a length of the sound signal, and setting the capturing window to begin at the capturing start time and to end at the capturing end time.

In another embodiment, the computer-readable medium storing program code, when executed by the second device performs the steps of determining the capturing start time to be shortly prior to the second time, and determining the capturing end time to be shortly after the second time and the length of the sound signal.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A second device for measuring a distance from a first device, the second device comprising:
an electromagnetic receiver configured to receive an electromagnetic signal, wherein the electromagnetic signal is received at a first time, the electromagnetic signal being transmitted by the first device,
a sound receiver configured to receive a sound signal, wherein the sound signal is received at a second time after the first time, the sound signal being transmitted by the first device, wherein the electromagnetic signal and the sound signal are transmitted substantially at the same time, and
a processor configured to:
approximate the distance of the second device from the first device based on the first time,
set a capturing window for capturing the sound signal based on the approximated distance of the second device from the first device,
capture the sound signal received by the second device within the set capturing window, and
determine the distance of the second device from the first device based on the first time and the captured sound signal.

2. The second device of claim 1, wherein to set the capturing window, the processor is configured to:
determine a capturing start time based on the approximated distance of the second device from the first device, and
set the capturing window as a fixed duration to begin at the capturing start time.

3. The second device of claim 2, wherein the processor is configured to determine the capturing start time to be shortly prior to the second time.

4. The second device of claim 1 wherein to set the capturing window, the processor is configured to:
determine a capturing start time based on the approximated distance of the second device from the first device, and
determine a capturing end time based on the approximated distance of the second device from the first device and a length of the sound signal, and
set the capturing window to begin at the capturing start time and to end at the capturing end time.

5. The second device of claim 4, wherein the processor is configured to determine the capturing start time to be shortly prior to the second time and to determine the capturing end time to be shortly after the second time and the length of the sound signal.

6. The second device of claim 1 wherein the electromagnetic receiver is a radio antenna and the sound receiver is a microphone.

7. The second device of claim 1 wherein the electromagnetic signal is a radio signal.

8. The second device of claim 1 wherein the sound signal is an ultrasound signal.

9. A method, performed by a second device, of measuring a distance from a first device, comprising the steps of:
receiving an electromagnetic signal transmitted by the first device, wherein the electromagnetic signal is received at a first time,
approximating the distance of the second device from the first device based on the first time,
setting a capturing window for capturing a sound signal transmitted by the first device, wherein setting the capturing window is based on the approximated distance of the second device from the first device,
receiving the sound signal, wherein the sound signal is received at a second time after the first time,
capturing the sound signal received by the second device within the set capturing window, and
determining the distance of the second device from the first device based on the first time and the captured sound signal.

10. The method of claim 9, wherein setting the capturing window comprises:
determining a capturing start time based on the approximated distance of the second device from the first device, and
setting the capturing window as a fixed duration to begin at the capturing start time.

11. The method of claim 10, wherein determining the capturing start time comprises determining the capturing start time to be shortly prior to the second time.

12. The method of claim 9, wherein setting the capturing window comprises:
determining a capturing start time based on the approximated distance of the second device from the first device,
determining a capturing end time based on the approximated distance of the receiving device from the transmitting device and a length of the sound signal, and
setting the capturing window to begin at the capturing start time and to end at the capturing end time.

13. The method of claim 12, wherein determining the capturing start time comprises determining the capturing start time to be shortly prior to the second time, and wherein determining the capturing end time comprises determining the capturing end time to be shortly after the second time and the length of the sound signal.

14. The method of claim 10, wherein the second device comprises an electromagnetic receiver for receiving the electromagnetic signal and a sound receiver for receiving the sound signal.

15. The method of claim 10, wherein the electromagnetic receiver is a radio antenna and the sound receiver is a microphone.

16. A computer-readable medium storing program code which when executed by a second device performs the steps of:
receiving an electromagnetic signal transmitted by a first device, wherein the electromagnetic signal is received at a first time,
approximating a distance of the second device from the first device based on the first time,
setting a capturing window for capturing a sound signal transmitted by the first device, wherein setting the capturing window is based on the approximated distance of the second device from the first device,
receiving the sound signal, wherein the sound signal is received at a second time after the first time,
capturing the sound signal received by the second device within the set capturing window, and
determining the distance of the second device from the first device based on the first time and the captured sound signal.

17. The computer-readable medium storing program code of claim 16, which when executed by the second device performs the step of setting the capturing window by:
determining a capturing start time based on the approximated distance of the second device from the first device, and
setting the capturing window as a fixed duration to begin at the capturing start time.

18. The computer-readable medium storing program code of claim 17, which when executed by the second device performs the step of determining the capturing start time to be shortly prior to the second time.

19. The computer-readable medium storing program code of claim 16, which when executed by the second device performs the step of setting the capturing window by:
determining a capturing start time based on the approximated distance of the second device from the first device,
determining a capturing end time based on the approximated distance of the second device from the first device and a length of the sound signal, and
setting the capturing window to begin at the capturing start time and to end at the capturing end time.

20. The computer-readable medium storing program code of claim 19, which when executed by the second device performs the steps of:
determining the capturing start time to be shortly prior to the second time, and
determining the capturing end time to be shortly after the second time and the length of the sound signal.
